(19) United States
(12) Patent Application Publication
(10) Pub. No.: US 2008/0316492 A1
(43) Pub. Date: Dec. 25, 2008

(54) Optical motion identification device utilizing partial total internal reflection light source and/or partial non-total internal reflection light source

(76) Inventors: Chia-Chu Cheng, Yonghe City (TW); Jau-Yu Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,205

(22) Filed: Mar. 28, 2008

(30) Foreign Application Priority Data
Jun. 22, 2007 (TW) 96122545

(51) Int. Cl. G01N 21/55

(52) U.S. Cl. 356/445

(57) ABSTRACT

An optical motion identification device utilizing partial total internal reflection light source and/or partial non-total internal reflection light source includes a light-emitting member, a code member and a light-sensing unit. The light-emitting member generates projecting light beams. The code member receives the projecting light beams generated by the light-emitting member at different angles and positions, and the code member has many total internal reflection surfaces in order to make the projecting light beams form many partial total internal reflection beams and a plurality of partial non-total internal reflection beams. The light-sensing unit disposes beside the code member for detecting the light intensity distribution of the partial total internal reflection beams and/or the partial non-total internal reflection beams projected on the light-sensing unit in order to determining a direction, a displacement, or a rotation angle of a movement of the code member relative to the light-emitting member or the light-sensing unit.

### BACKGROUND OF THE INVENTION

1. Field of the Invention

The present invention relates to an optical motion identification device, and particularly relates to an optical motion identification device utilizing partial total internal reflection light source and/or partial non-total internal reflection light source.

2. Description of the Related Art

FIG. 1A depicts an example optical encoding system that includes a codewheel 10a, a light source 20a, and a photodetector array 30a. The codewheel 10a has a pattern of transparent sections 100a and opaque sections 110a that alternatively pass and block light L1 from the light source 20a. The optical encoding system is configured such that light L1 passes through the transparent sections 100a of the codewheel 10a and is detected by the photodetector array 30a that is located on the other side of the codewheel 10a.

Because light L1 passes through the transparent sections 100a of the codewheel 10a, this type of optical encoding system is referred to as a “transmissive” optical encoding system. Transmissive optical encoders are able to generate output signals with good contrast between light and dark and as a result are able to operate at high speeds with relatively high resolution. Although transmissive optical encoding systems provide high quality outputs, the transmissive configuration requires that the light source 20a and photodetector array 30a be located on opposite sides of the codewheel 10a, thereby putting limitations on the profile dimension of the encoding system.

Optical encoding systems that utilize reflection instead of transmission also exist and are referred to as “reflective” optical encoding systems. FIG. 1b depicts an example reflective optical encoding system that includes a codewheel 10b with a pattern of reflective sections 100b and non-reflective sections 110b that alternatively reflect and absorb (or diffuse or pass etc.) light L2 from a light source 20b. The reflected light is then detected by a photodetector array 30b.

Because portions of the codewheel 10b are reflective, the light source 20b and photodetector array 30b can be located on the same side of the codewheel 10b, thereby allowing for a compact profile dimension. Although reflective optical encoding systems are conducive to a compact profile, they suffer from relatively low signal contrast, which restricts the speed and resolution of these encoding systems.

### SUMMARY OF THE INVENTION

One particular aspect of the present invention is to provide an optical motion identification device utilizing partial total internal reflection light source and/or partial non-total internal reflection light source. The present invention uses an undulate transparent structure with total internal reflection surfaces to make projecting light beams from different angle pass through a code member to generate partial total internal reflection light source and/or partial non-total internal reflection light source in order to determining the movement information of the code member relative to a light-emitting member or a light-sensing unit. Hence, the structure of the present invention is simple. Furthermore, the light-emitting member and the light-sensing unit can be disposed two sides of the code member or beside the same side of the code member.

In order to achieve the above-mentioned aspects, the present invention provides an optical motion identification device utilizing partial total internal reflection light source and/or partial non-total internal reflection light source, including: a light-emitting member, a code member, and a light-sensing unit.

The light-emitting member is used to generate projecting light beams. The code member is used to receive the projecting light beams generated by the light-emitting member at different angles and positions, and the code member has a plurality of total internal reflection surfaces in order to make the projecting light beams form a plurality of partial total internal reflection beams and a plurality of partial non-total internal reflection beams. The light-sensing unit is disposed beside the code member for detecting the light intensity distribution of the partial total internal reflection beams and/or the partial non-total internal reflection beams projected on the light-sensing unit in order to determining a direction, a displacement, or a rotation angle of a movement of the code member relative to the light-emitting member or the light-sensing unit.

Therefore, when code member is moved relative to the light-emitting member or the light-sensing unit, the projecting light beams from different angle pass through the code member to generate partial total internal reflection light source and/or partial non-total internal reflection light source. Hence, the direction, the displacement and the rotation angle of the movement of the code member are obtained according to the different light distribution of the partial total internal reflection light source and/or the partial non-total internal reflection light source projected onto the light-sensing unit.

It is to be understood that both the foregoing general description and the following detailed description are exemplary, and are intended to provide further explanation of the invention as claimed.-Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is a side, schematic view of a transmissive optical encoding device of the prior art;

FIG. 1B is a side, schematic view of a reflective optical encoding device of the prior art;

FIG. 2 is a perspective view of a first type of code member according to the present invention;

FIG. 3A-3D are schematic views (from state 1 to state 4) of an optical motion identification device utilizing partial total internal reflection light source and/or partial non-total internal reflection light source according to the first embodiment of the present invention, respectively;

FIG. 4 is a functional block diagram (from state 1 to state 4) of an optical motion identification device utilizing partial total internal reflection light source and/or partial non-total internal reflection light source according to the first embodiment of the present invention;

FIG. 5A-5D are schematic views (from state 1 to state 4) of an optical motion identification device utilizing partial total internal reflection light source and/or partial non-total internal reflection light source according to the second embodiment of the present invention, respectively;

FIG. 6 is a functional block diagram (from state 1 to state 4) of an optical motion identification device utilizing partial total internal reflection light source and/or partial non-total internal reflection light source according to the second embodiment of the present invention;

FIG. 7A-7D are schematic views (from state 1 to state 4) of an optical motion identification device utilizing partial total internal reflection light source and/or partial non-total internal reflection light source according to the third embodiment of the present invention, respectively;

FIG. 8 is a functional block diagram (from state 1 to state 4) of an optical motion identification device utilizing partial total internal reflection light source and/or partial non-total internal reflection light source according to the third embodiment of the present invention;

FIG. 9 is a perspective view of a second type of code member according to the present invention; and

FIG. 10 is a perspective view of a third type of code member according to the present invention.

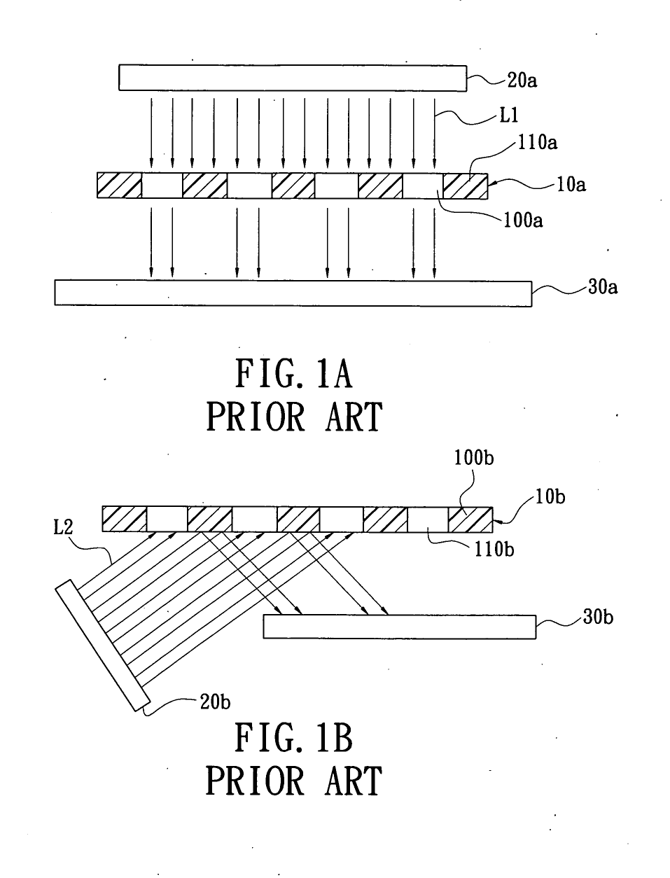

### DETAILED DESCRIPTION OF THE PREFERRED EMBODIMENTS

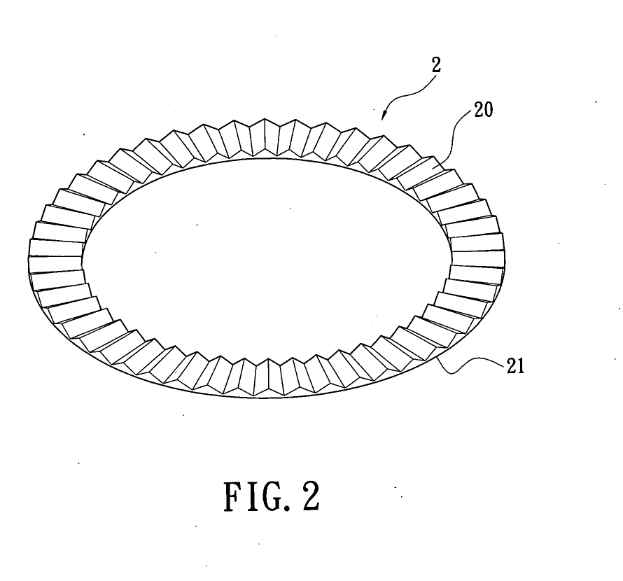

Referring to FIGS. 2, 3A-3D and 4, the first embodiment provides an optical motion identification device utilizing partial total internal reflection light source and/or partial non-total internal reflection light source, including: a light-emitting member 1, a code member 2 and a light-sensing unit 3.

The light-emitting member 1 is used to generate projecting light beams S, and the light-emitting member 1 can be an LED or a LASER device. As shown in FIG. 2, the shape of the code member 2 has an annular shape as a code wheel, and the code member 2 is an undulate transparent structure that is a periodic undulated structure. In addition, the periodic undulated structure is a periodic triangular structure, and the refractive index of the undulate transparent structure is larger than the refractive index of air.

The relative position of the light-emitting member 1 with respect to the light-sensing unit 3 is fixed. The code member 2 is movable for receiving the projecting light beams S generated by the light-emitting member 1 at different angles and positions; Alternatively, both the light-emitting member 1 and the light-sensing unit 3 are moved relative to the code member 2, and the code member 2 is fixed for receiving the projecting light beams S generated by the light-emitting member 1 at different angles and positions.

The code member 2 has a plurality of total internal reflection surfaces 20 in order to make the projecting light beams S form a plurality of partial total internal reflection beams and a plurality of partial non-total internal reflection beams.

The light-sensing unit 3 is disposed beside the code member 2 for detecting the light intensity distribution of the partial total internal reflection beams and/or the partial non-total internal reflection beams projected on the light-sensing unit 3 in order to determining a direction, a displacement or a rotation angle of a movement of the code member 2 relative to the light-emitting member 1 or the light-sensing unit 3.

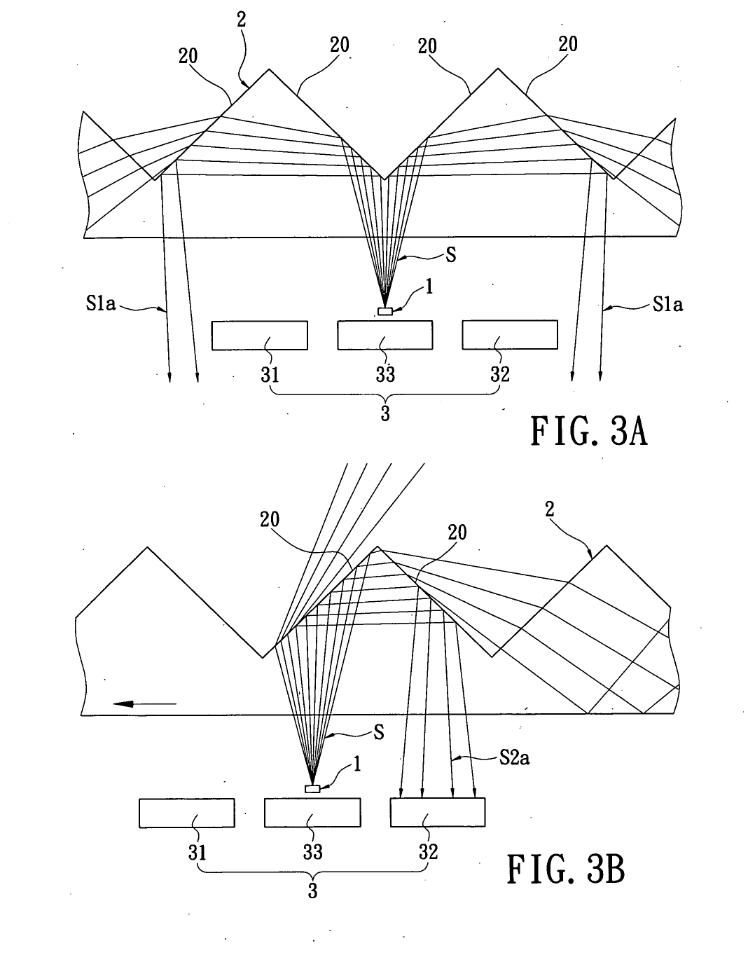

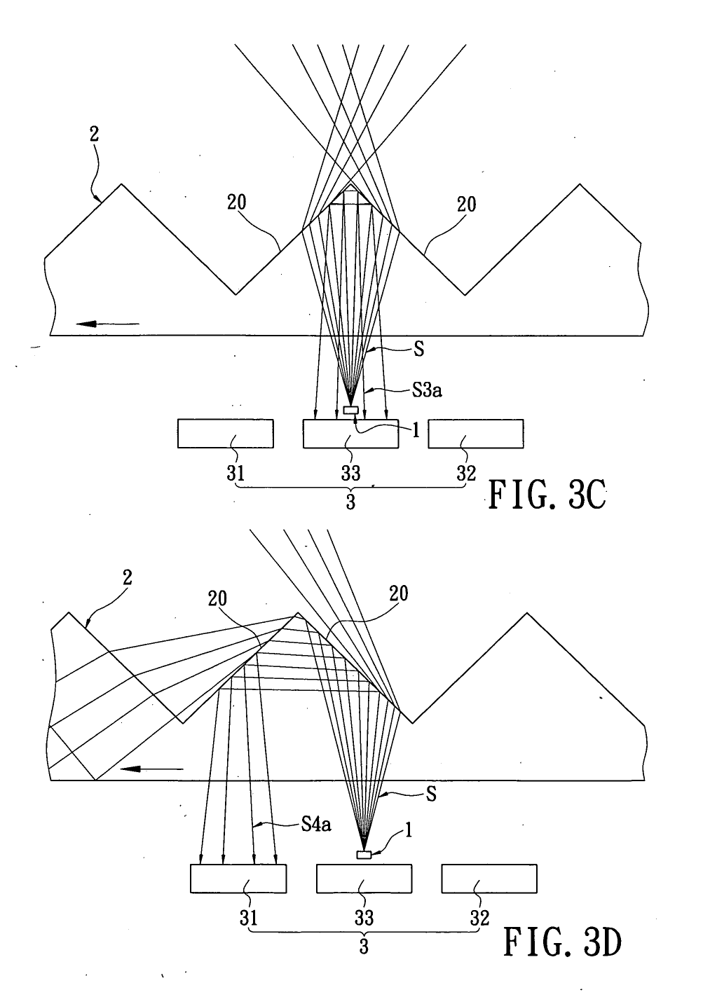

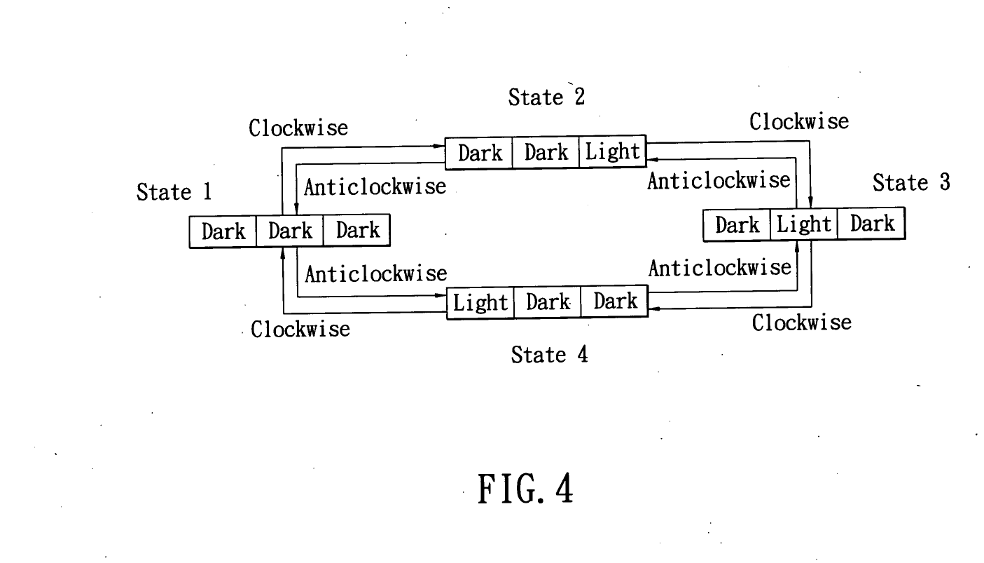

For example, as shown in FIGS. 3A-3D and 4, the bottom side of the code member 2 has a plane 21 and the top side of the code member 2 has an undulated structure with alternating crests and troughs. The projecting light beams S generated by the light-emitting member 1 are projected into the code member 2 from the bottom side of the code member 2. The light-sensing unit 3 has at least three light-sensing members disposed under the code member 2, and the at least three light-sensing members are a first light-sensing member 31, a middle light-sensing member 33, and a second light-sensing member 32 disposed in order.

Referring to FIGS. 3A and 4, when the projecting light beams S generated by the light-emitting member 1 are projected to the wave trough of the code member 2, the projecting light beams S pass through the total internal reflection surfaces 20 to form partial total internal reflection beams S1a that do not be projected onto the light-sensing unit 3. Hence, the first light-sensing member 31, the middle light-sensing member 33 and the second light-sensing member 32 respectively show dark, dark and dark in state 1 as shown in FIG. 4.

Referring to FIGS. 3B and 4 (the code member 2 has been rotated left as the direction of arrow), when the projecting light beams S generated by the light-emitting member 1 are projected to a middle position between the wave trough and the wave crest of the code member 2, the projecting light beams S pass through two of the total internal reflection surfaces 20 to form partial total internal reflection beams S2a that are projected onto the second light-sensing member 32 of the light-sensing unit 3. Hence, the first light-sensing member 31, the middle light-sensing member 33 and the second light-sensing member 32 respectively show dark, dark and light in state 2 as shown in FIG. 4.

Referring to FIGS. 3C and 4 (the code member 2 has been rotated left as the direction of arrow), when the projecting light beams S generated by the light-emitting member 1 are projected to the wave crest of the code member 2, the projecting light beams S pass through two of the total internal reflection surfaces 20 to form partial total internal reflection beams S3a that are projected onto the middle light-sensing member 33 of the light-sensing unit 3. Hence, the first light-sensing member 31, the middle light-sensing member 33 and the second light-sensing member 32 respectively show dark, light and dark in state 3 as shown in FIG. 4.

Referring to FIGS. 3D and 4 (the code member 2 has been rotated left as the direction of arrow), when the projecting light beams S generated by the light-emitting member 1 are projected to a middle position between the wave trough and the wave crest of the code member 2, the projecting light beams S pass through two of the total internal reflection surfaces 20 to form partial total internal reflection beams S4a that are projected onto the first light-sensing member 31 of the light-sensing unit 3. Hence, the first light-sensing member 31, the middle light-sensing member 33 and the second light-sensing member 32 respectively show light, dark and dark in state 4 as shown in FIG. 4. Hence, referring to FIG. 4, when the code member 2 is continuously rotated left, the first light-sensing member 31, the middle light-sensing member 33 and the second light-sensing member 32 respectively show “dark, dark, dark” (state 1), “dark, dark, light” (state 2), “dark, light, dark” (state 3), and “light, dark, dark” (state 4). According to the same principle, when the code member 2 is continuously rotated right, the first light-sensing member 31, the middle light-sensing member 33 and the second light-sensing member 32 respectively show “dark, dark, dark” (state 1), “light, dark, dark” (state 4), “dark, light, dark” (state 3), and “dark, dark, light” (state 2). In other words, the direction, the displacement and the rotation angle of the movement of the code member 2 are obtained according to the variation shown by the first light-sensing member 31, the middle light-sensing member 33 and the second light-sensing member 32.

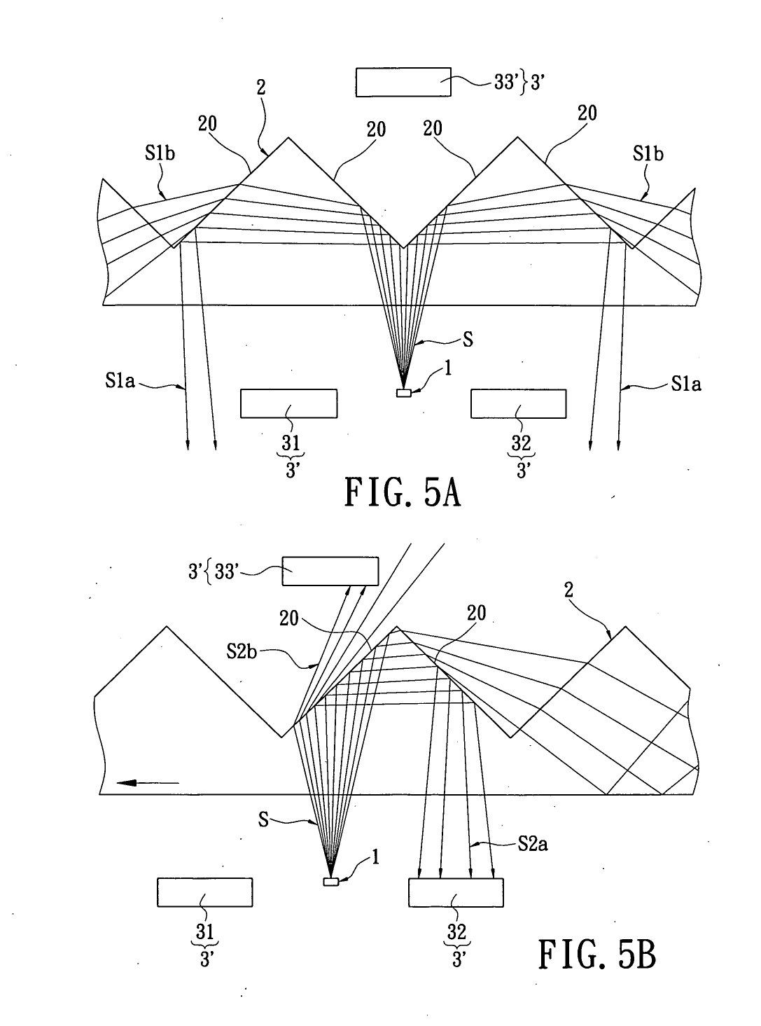

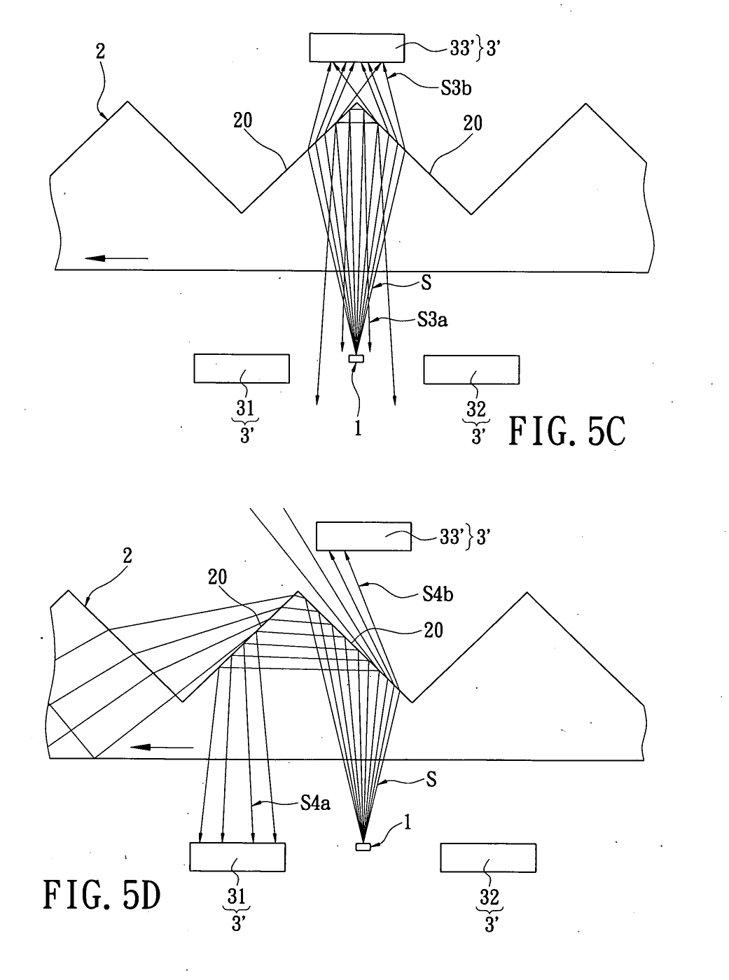

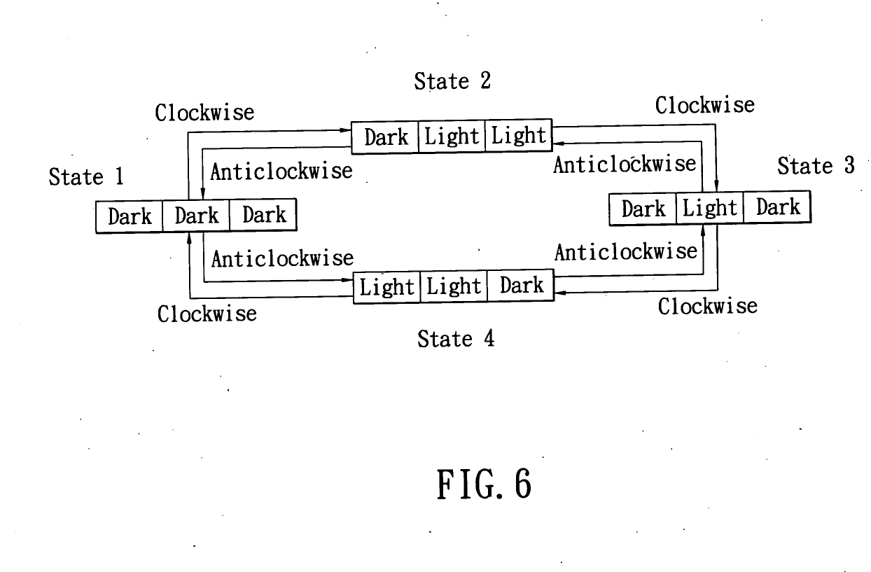

Referring to FIGS. 5A-5D and 6, the light-sensing unit 3′ has at least two light-sensing members disposed under the code member 2 and at least one light-sensing member disposed over the code member 2. The at least two light-sensing members disposed under the code member 2 are a first light-sensing member 31 and a second light-sensing member 32, and the at least one light-sensing member disposed over the code member 2 is a middle light-sensing member 33′ between the first light-sensing member 31 and the second light-sensing member 32. Referring to FIGS. 5A and 6, when the projecting light beams S generated by the light-emitting member 1 are projected to the wave trough of the code member 2, the projecting light beams S pass through the total internal reflection surfaces 20 to form partial total internal reflection beams S1a and partial non-total internal reflection beams S1b that do not be projected onto the light-sensing unit 3′. Hence, the first light-sensing member 31, the middle light-sensing member 33′ and the second light-sensing member 32 respectively show dark, dark and dark in state 1 as shown in FIG. 6.

Referring to FIGS. 5B and 6 (the code member 2 has been rotated left as the direction of arrow), when the projecting light beams S generated by the light-emitting member 1 are projected to a middle position between the wave trough and the wave crest of the code member 2, the projecting light beams S pass through the total internal reflection surfaces 20 to form partial non-total internal reflection beams S2b and partial total internal reflection beams S2a that are respectively projected onto the middle light-sensing member 33′ and the second light-sensing member 32 of the light-sensing unit 3′. Hence, the first light-sensing member 31, the middle light-sensing member 33′ and the second light-sensing member 32 respectively show dark, light and light in state 2 as shown in FIG. 6.

Referring to FIGS. 5C and 6 (the code member 2 has been rotated left as the direction of arrow), when the projecting light beams S generated by the light-emitting member 1 are projected to the wave crest of the code member 2, the projecting light beams S pass through the total internal reflection surfaces 20 to form partial non-total internal reflection beams S3b that are projected onto the middle light-sensing member 33′ of the light-sensing unit 3′. Hence, the first light-sensing member 31, the middle light-sensing member 33′ and the second light-sensing member 32 respectively show dark, light and dark in state 3 as shown in FIG. 6.

Referring to FIGS. 5D and 6 (the code member 2 has been rotated left as the direction of arrow), when the projecting light beams S generated by the light-emitting member 1 are projected to a middle position between the wave trough and the wave crest of the code member 2, the projecting light beams S pass through the total internal reflection surfaces 20 to form partial non-total internal reflection beams S4b and partial total internal reflection beams S4a that are respectively projected onto the middle light-sensing member 33′ and the first light-sensing member 31 of the light-sensing unit 3′. Hence, the first light-sensing member 31, the middle light-sensing member 33′ and the second light-sensing member 32 respectively show light, light and dark in state 4 as shown in FIG. 6.

Hence, referring to FIG. 6, when the code member 2 is continuously rotated left, the first light-sensing member 31, the middle light-sensing member 33′ and the second light-sensing member 32 respectively show “dark, dark, dark” (state 1), “dark, light, light” (state 2), “dark, light, dark” (state 3), and “light, light, dark” (state 4). According to the same principle, when the code member 2 is continuously rotated right, the first light-sensing member 31, the middle light-sensing member 33′ and the second light-sensing member 32 respectively show “dark, dark, dark” (state 1), “light, light, dark” (state 4), “dark, light, dark” (state 3), and “dark, light, light” (state 2). In other words, the direction, the displacement and the rotation angle of the movement of the code member 2 are obtained according to the variation shown by the first light-sensing member 31, the middle light-sensing member 33′ and the second light-sensing member 32.

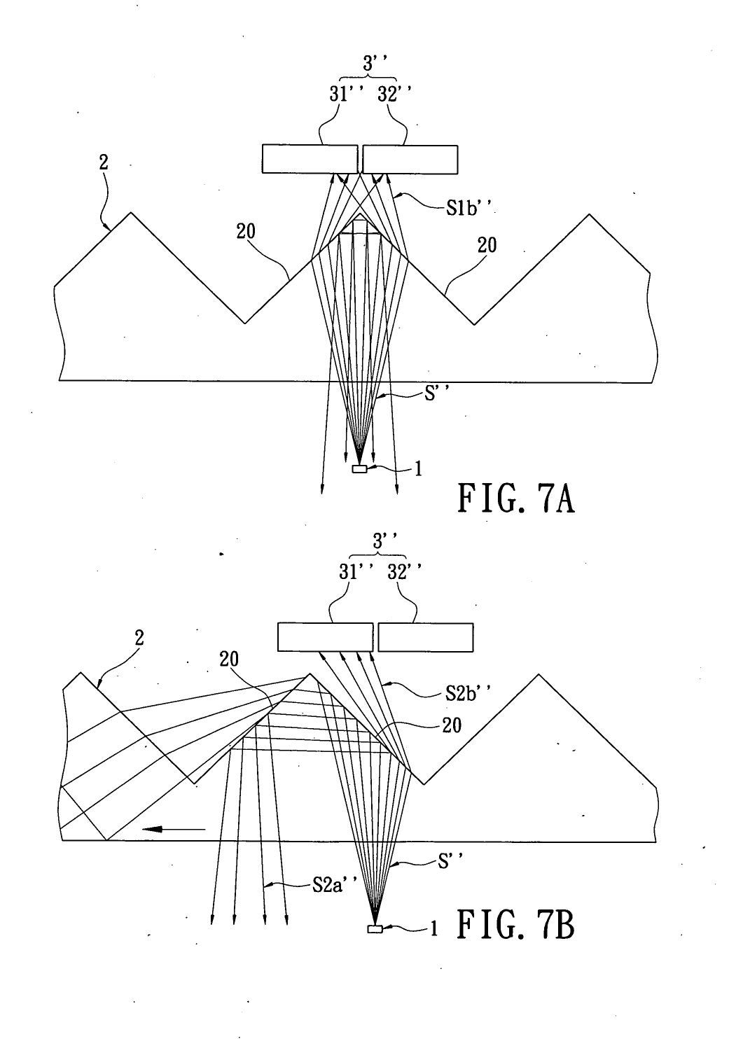

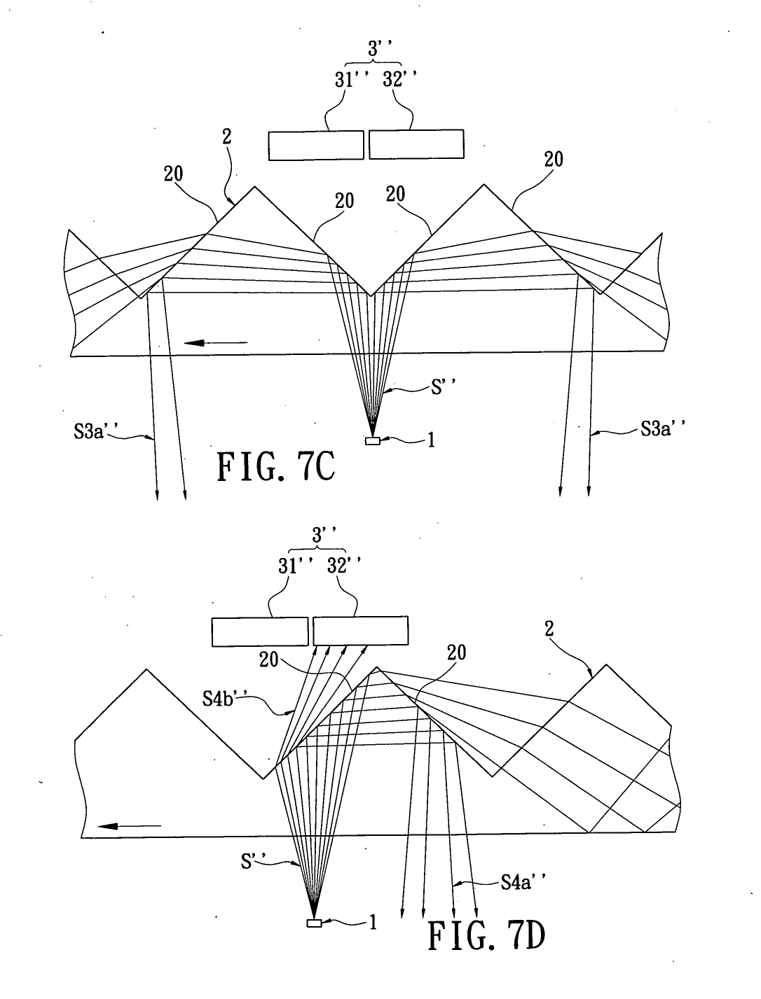

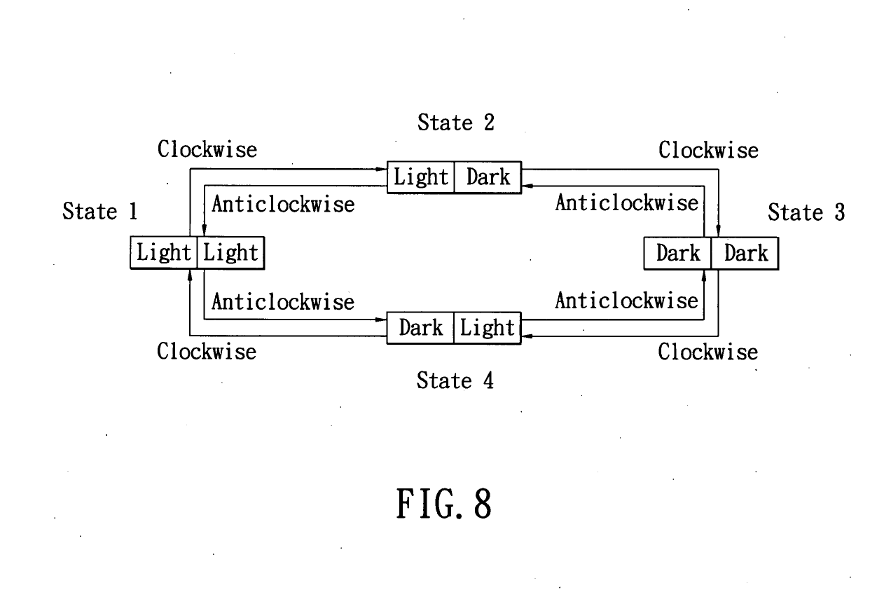

Referring to FIGS. 7A-7D and 8, the light-sensing unit 3″ has at least two light-sensing members disposed over the code member 2, and the at least two light-sensing members are a first light-sensing member 31″ and a second light-sensing member 32″.

Referring to FIGS. 7A and 8, when the projecting light beams S″ generated by the light-emitting member 1 are projected to the wave crest of the code member 2, the projecting light beams S″ pass through two of the total internal reflection surfaces 20 to form partial non-total internal reflection beams S1b″ that are projected onto the first light-sensing member 31″ and the second light-sensing member 32″ of the light-sensing unit 3″ at the same time. Hence, the first light-sensing member 31″ and the second light-sensing member 32″ respectively show light and light in state 1 as shown in FIG. 8.

Referring to FIGS. 7B and 8 (the code member 2 has been rotated left as the direction of arrow), when the projecting light beams S″ generated by the light-emitting member 1 are projected to a middle position between the wave trough and the wave crest of the code member 2, the projecting light beams S″ pass through one of the total internal reflection surfaces 20 to form partial non-total internal reflection beams S2b″ that are projected onto the first light-sensing member 31″ of the light-sensing unit 3″. Hence, the first light-sensing member 31″ and the second light-sensing member 32″ respectively show light and dark in state 2 as shown in FIG. 8.

Referring to FIGS. 7C and 8 (the code member 2 has been rotated left as the direction of arrow), when the projecting light beams S″ generated by the light-emitting member 1 are projected to the wave trough of the code member 2, the projecting light beams S″ pass through the total internal reflection surfaces 20 to form partial total internal reflection beams S3a″ that do not be projected onto the light-sensing unit 3″. Hence, the first light-sensing member 31″ and the second light-sensing member 32″ respectively show dark and dark in state 3 as shown in FIG. 8.

Referring to FIGS. 7D and 8 (the code member 2 has been rotated left as the direction of arrow), when the projecting light beams S″ generated by the light-emitting member 1 are projected to a middle position between the wave crest and the wave trough of the code member 2, the projecting light beams S″ pass through one of the total internal reflection surfaces 20 to form partial non-total internal reflection beams S4b″ that are projected onto the second light-sensing member 32″ of the light-sensing unit 3″. Hence, the first light-sensing member 31″ and the second light-sensing member 32″ respectively show dark and light in state 4 as shown in FIG. 8.

Hence, referring to FIG. 8, when the code member 2 is continuously rotated left, the first light-sensing member 3 1″ and the second light-sensing member 32″ respectively show “light, light″ (state 1), “light, dark” (state 2), “dark, dark” (state 3), and “dark, light” (state 4). According to the same principle, when the code member 2 is continuously rotated right, the first light-sensing member 31″ and the second light-sensing member 32” respectively show “light, light” (state 1), “dark, light” (state 4), “dark, dark” (state 3), and “light, dark” (state 2). In other words, the-direction, the displacement and the rotation angle of the movement of the code member 2 are obtained according to the variation shown by the first light-sensing member 31″ and the second light-sensing member 32″.

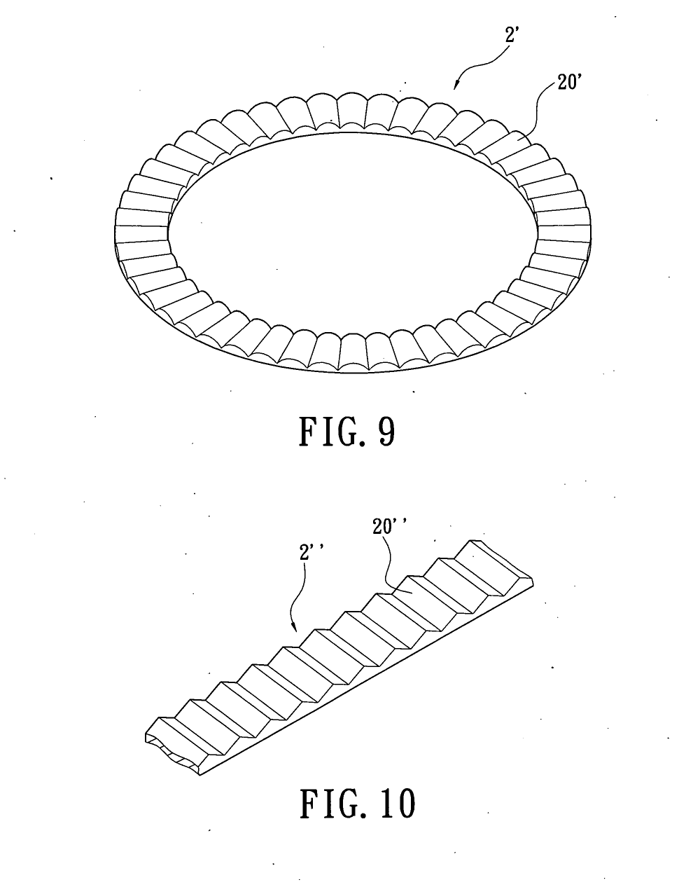

Referring to FIG. 9, the code member 2′ is a periodic undulated structure that can be a periodic semi-arc structure, and the periodic semi-arc structure has a plurality of cambered surfaces 20′.

Referring to FIG. 10, the shape of the code member 2″ is strip-shaped, and the code member 2″ has a plurality of total internal reflection surfaces 20″. In other words, the code member (2, 2′, 2″) can be a linear framework as shown in FIG. 10 or an annular framework as shown in FIG. 9.

However, the three code member (2, 2′, 2″) are examples and do not limit the present invention. The undulated structure with any shapes is projected in the present invention. For example, the code member can be a non-periodic undulated structure or a framework with any shapes.

In conclusion, the present invention use an undulate transparent structure with total internal reflection surfaces to make projecting light beams from different angle pass through a code member to generate partial total internal reflection light source and/or partial non-total internal reflection light source in order to determining the movement information of the code member relative to a light-emitting member or a light-sensing unit. Hence, the structure of the present invention is simple. Furthermore, the light-emitting member and the light-sensing unit can be disposed two sides of the code member or beside the same side of the code member.

Therefore, when code member is moved relative to the light-emitting member or the light-sensing unit, the projecting light beams from different angle pass through the code member to generate partial total internal reflection light source and/or partial non-total internal reflection light source. Hence, the direction, the displacement and the rotation angle of the movement of the code member are obtained according to the different light distribution of the partial total internal reflection light source and/or the partial non-total internal reflection light source projected onto the light-sensing unit.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical motion identification device utilizing partial total internal reflection light source and/or partial non-total internal reflection light source, comprising:
a light-emitting member for generating projecting light beams;
a code member for receiving the projecting light beams generated by the light-emitting member at different angles and positions, wherein the code member has a plurality of total internal reflection surfaces in order to make the projecting light beams form a plurality of partial total internal reflection beams and a plurality of partial non-total internal reflection beams; and
a light-sensing unit disposed beside the code member for detecting the light intensity distribution of the partial total internal reflection beams and/or the partial non-total internal reflection beams projected on the light-sensing unit in order to determining a direction, a displacement, or a rotation angle of a movement of the code member relative to the light-emitting member or the light-sensing unit.

2. The optical motion identification device as claimed in claim 1, wherein the relative position of the light-emitting member with respect to the light-sensing unit is fixed, and the code member is movable for receiving the projecting light beams generated by the light-emitting member at different angles and positions.

3. The optical motion identification device as claimed in claim 1, wherein the relative position of the light-emitting member with respect to the light-sensing unit is fixed, both the light-emitting member and the light-sensing unit are moved relative to the code member, and the code member is fixed for receiving the projecting light beams generated by the light-emitting member at different angles and positions.

4. The optical motion identification device as claimed in claim 1, wherein the code member has a plane formed on its bottom side and an undulated structure with alternating crests and troughs formed on its top side, and the projecting light beams generated by the light-emitting member is projected into the code member from the bottom side of the code member.

5. The optical motion identification device as claimed in claim 4, wherein the light-sensing unit has at least three light-sensing members disposed under the code member, and the at least three light-sensing members are a first light-sensing member, a middle light-sensing member, and a second light-sensing member disposed in order.

6. The optical motion identification device as claimed in claim 4, wherein the light-sensing unit has at least two light-sensing members disposed under the code member and at least one light-sensing member disposed over the code member, the at least two light-sensing members disposed under the code member are a first light-sensing member and a second light-sensing member, and the at least one light-sensing member disposed over the code member is a middle light-sensing member between the first light-sensing member and the second light-sensing member.

7. The optical motion identification device as claimed in claim 4, wherein the light-sensing unit has at least two light-sensing members disposed over the code member, and the at least two light-sensing members are a first light-sensing member and a second light-sensing member.

8. The optical motion identification device as claimed in claim 1, wherein the light-emitting member is an LED or a LASER device.

9. The optical motion identification device as claimed in claim 1, wherein the code member is an undulate transparent structure.

10. The optical motion identification device as claimed in claim 9, wherein the refractive index of the undulate transparent structure is larger than the refractive index of air.

11. The optical motion identification device as claimed in claim 9, wherein the undulate transparent structure is a non-periodic undulated structure.

12. The optical motion identification device as claimed in claim 9, wherein the undulate transparent structure is a periodic undulated structure.

13. The optical motion identification device as claimed in claim 12, wherein the periodic undulated structure is a periodic triangular structure.

14. The optical motion identification device as claimed in claim 12, wherein the periodic undulated structure is a periodic semi-arc structure.

15. The optical motion identification device as claimed in claim 1, wherein the shape of the code member has an annular shape.

16. The optical motion identification device as claimed in claim 1, wherein the shape of the code member is strip-shaped.
